(19) United States
(12) Patent Application Publication
(10) Pub. No.: US 2026/0042063 A1
(43) Pub. Date: Feb. 12, 2026

(54) ELECTROCHEMICAL SYSTEMS FOR CAPTURE OF ACID GASES

(71) Applicant: Verdox, Inc., Woburn, MA (US)

(72) Inventors: Alexander Liu, Cambridge, MA (US); Liam Norton, Bridgewater, MA (US); Surya Effendy, Woburn, MA (US); James Phelan, Woburn, MA (US)

(21) Appl. No.: 19/289,483

(22) Filed: Aug. 4, 2025

Related U.S. Application Data
(60) Provisional application No. 63/680,669, filed on Aug. 8, 2024.

(51) Int. Cl. B01D 53/96; B01D 19/00; B01D 53/62; B01D 53/78

(52) U.S. Cl. CPC B01D 53/965; B01D 19/0068; B01D 53/62; B01D 53/78; B01D 2257/504

(57) ABSTRACT

A redox flow acid-gas capture system includes an electrochemical cell including a cathode configured to contact a stream including an electroactive species in an inactive state and provide a reduced stream including the electroactive species in an active state, and an anode configured to contact an adduct stream including an adduct of an electroactive species and an acid-gas and provide an oxidized stream including the electroactive species in the inactive state and the acid-gas; an absorber configured to contact the reduced stream and the acid-gas and form the adduct stream including the adduct of the electroactive species and the acid-gas; and at least one of an oxygen stripper unit, or a degasser unit configured to provide a degassed stream including the electroactive species in an inactive state, and an acid-gas stream.

### CROSS-REFERENCE TO RELATED APPLICATION

This application claims priority to U.S. Provisional Application No. 63/680,669, filed on Aug. 8, 2024, and all the benefits accruing therefrom under 35 U.S.C. § 119, the content of which is hereby incorporated by reference in its entirety.

### BACKGROUND

Removing target species from gas mixtures has been the subject of much research and development. For example, there have been efforts to mitigate global warming by curbing carbon dioxide emissions. To this end a number of approaches have been explored, and in recent years, many new technologies with solid or liquid sorbents have been considered. To avoid the sometimes complex or expensive temperature and pressure swings that these sorbents rely on, electrochemically mediated separation techniques have drawn interest. Electroswing adsorption (ESA) may operate isothermally at a variety of temperatures, have the potential to desorb a range of target species at elevated or ambient pressure, and may be coupled directly to renewable energy sources. While ESA is an effective process for removing a target species from gas streams, the durability of the materials can be a limiting factor for the ESA process.

Accordingly, there remains a need for improved electroswing adsorption systems or processes that provide improved durability or lifetime.

### SUMMARY

A redox flow acid-gas capture system comprises an electrochemical cell comprising a cathode configured to contact a stream comprising an electroactive species in an inactive state and provide a reduced stream comprising the electroactive species in an active state, and an anode configured to contact an adduct stream comprising an adduct of an electroactive species and an acid-gas and provide an oxidized stream comprising the electroactive species in the inactive state and the acid-gas; an absorber configured to contact the reduced stream comprising the electroactive species in the active state and the acid-gas and form the adduct stream comprising the adduct of the electroactive species and the acid-gas; and at least one of an oxygen stripper unit configured to remove O₂ from the adduct stream and provide a stripped adduct stream having an O₂ content that is less than an O₂ content of the adduct stream to the oxidizer and a stripped-gas stream, a degasser unit configured to provide a degassed stream comprising the electroactive species in an inactive state, and an acid-gas stream, or wherein the electrochemical cell is configured to provide a degassed stream comprising the electroactive species in the oxidized state and the acid-gas stream.

A redox flow acid-gas capture system comprises a first electrochemical cell comprising a cathode configured to contact a first stream comprising an electroactive species in an inactive state and provide a reduced stream comprising the electroactive species in an active state, and an anode configured to contact a second stream comprising a second electroactive species in a reduced state and provide the second electroactive species in an oxidized state; an absorber configured to contact the electroactive species in the active state and an acid-gas and form an adduct stream comprising an adduct of the first electroactive species and the acid-gas; a second electrochemical cell comprising a cathode configured to reduce the second electroactive species in the oxidized state and provide the second electroactive species in the reduced state, and an anode configured to oxidize the adduct and provide an oxidized stream comprising the electroactive species in the inactive state and the acid-gas; and a degasser configured to separate the acid-gas and oxygen from the oxidized stream comprising the electroactive species in the inactive state and the acid-gas and provide a degassed stream comprising the electroactive species in the inactive state having an oxygen content that is less than an oxygen content of the oxidized stream.

A method of separating a target gas from a fluid mixture, the method comprising providing the fluid mixture to the redox flow acid-gas capture system.

### BRIEF DESCRIPTION OF THE DRAWINGS

Referring to the exemplary non-limiting drawings wherein like elements are numbered alike in the accompanying Figures:

FIG. 1 is a schematic illustration of a redox-flow acid-gas capture system according to an aspect of the present disclosure;

FIG. 2 is a schematic illustration of a redox-flow acid-gas capture system according to an aspect of the present disclosure;

FIG. 3A is a schematic illustration of a redox-flow acid-gas capture system according to an aspect of the present disclosure;

FIG. 3B is a schematic illustration of a redox-flow acid-gas capture system according to an aspect of the present disclosure;

FIG. 4 is a schematic illustration of a redox-flow acid-gas capture system according to an aspect of the present disclosure;

FIG. 5A is a graph of voltage (volts, solid line) and charge capacity (coulombs, C, dotted line) versus time (hours);

FIG. 5B is a graph of oxygen content (arbitrary units) versus time (hours);

FIG. 6A is a graph of carbon dioxide concentration (%) versus time (days);

FIG. 6B is a graph of molar CO₂ capture rate (solid line) and release rate (dashed line) versus time (days);

FIG. 7A is a graph of carbon dioxide concentration (%) versus time (days);

FIG. 7B is a graph of graph of molar CO₂ capture rate (solid line) and release rate (dashed line) versus time (days);

FIG. 7C is a graph of oxygen concentration (%) versus time (days); and

FIG. 7D is a graph of oxygen concentration (ppm) versus time (days).

### DETAILED DESCRIPTION

The Applicants have determined that exposure of the active materials and device components in electroswing adsorption systems to oxygen can result in deleterious processes, resulting in reduced durability or lifetime. Disclosed are configurations that provide reduced exposure of the electroactive materials, or cell components such as current collectors, to oxygen to provide systems that can process oxygen-containing gasses, such as air, and avoid the cost and complexity of alternative methods to remove or avoid oxygen, such as selective membranes or catalytic combustion.

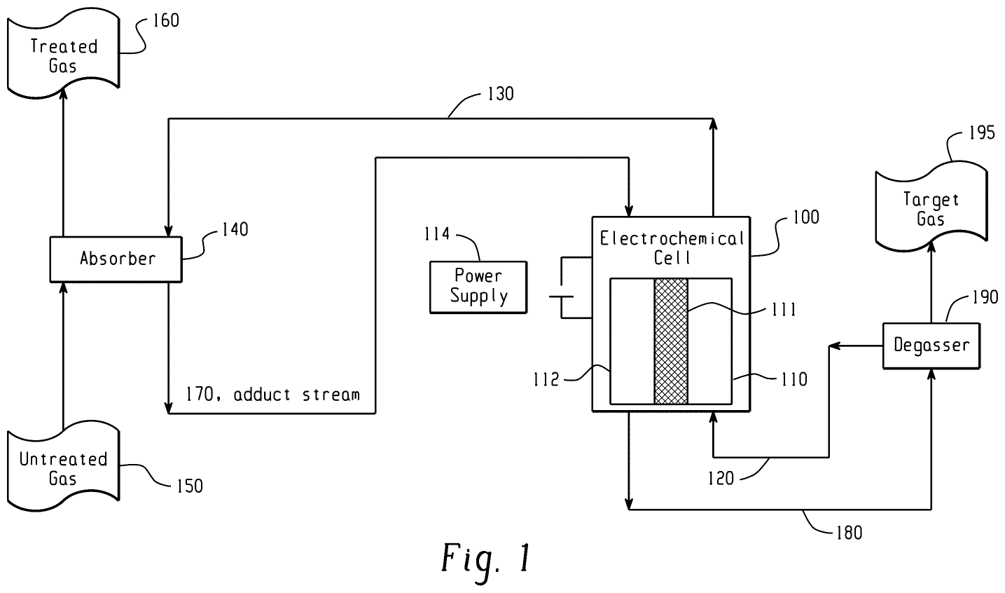

The redox-flow acid-gas capture system is shown schematically in FIG. 1. The system includes an electrochemical cell 100 comprising a cathode 110 configured to contact a second oxidized stream 120 comprising an electroactive species in an inactive state and provide a reduced stream 130 comprising the electroactive species in an active state. The reduced stream 130, comprising the electroactive species in an active state, is provided to an absorber 140. The absorber 140 is configured to contact an untreated gas stream 150 and the reduced stream 130 to form an adduct between the electroactive species and a Lewis acid-gas, i.e., an acid-gas, in the untreated gas stream and provide an adduct stream 170 comprising an electroactive species-acid-gas adduct and a treated gas stream 160 having a reduced content of the acid-gas. The electroactive species-acid-gas adduct formed in the absorber 140 is provided by the adduct stream 170 to an anode 112 of the electrochemical cell 100. The anode 112 is configured to contact the adduct stream 170, comprising the adduct of an electroactive species and the acid-gas, and oxidize the adduct to provide the first oxidized stream 180 comprising the electroactive species in the inactive state and the acid-gas. The electrochemical cell 100 may be powered by a power supply 114 to provide electrical power for the oxidation of the adduct. The power supply may be configured to provide 10 to 2000 amperes per square meter (A/m²), based on a total cathode and total anode area of the electrochemical cell. The power supply may be configured to create a potential difference of 0 to 2.0 volts (V), or greater than 0 to 2.0V, or 0.1 to 2.0V, or 0.1 to 1.8V, or 0.1 to 1.6V, or 0.1 to 1.5V, 0.1 to 1.0V, or 0.2 to 2.0V, or 0.2 to 1.8V, or 0.2 to 1.6V, or 0.2 to 1.4V, or 0.2 to 1.2V, or 0.2 to 1.0V, or 0.2 to 0.8V between the cathode and the anode of the electrochemical cell. The first oxidized stream 180 comprising the electroactive species in the inactive state, the acid-gas, and oxygen are then treated in a degasser 190 to separate liquids and gases and provide the second oxidized stream 120 comprising the electroactive species in the inactive state and an acid-gas stream 195 comprising the acid-gas and oxygen. By removing oxygen with the degasser 190, improved durability or life of the electroactive species and cell components has been observed. In some aspects, the system can optionally further comprise a vacuum pump in fluid communication with the degasser to facilitate removal of the acid-gas stream 195.

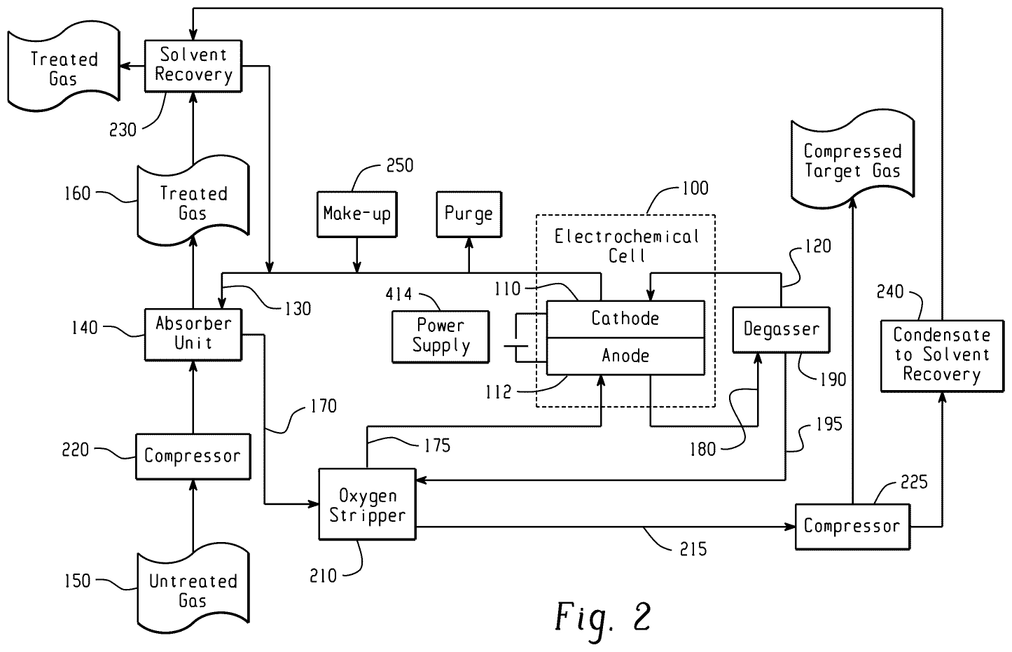

An embodiment of the redox-flow acid-gas capture system is shown schematically in FIG. 2. The redox-flow acid-gas capture system shown in FIG. 2 is conceptually comparable to that of FIG. 1, and further includes additional components and alternative configurations to provide improved performance. As shown in FIG. 2, the adduct stream 170 and/or the acid-gas stream 195 from the degasser may be provided to an oxygen stripper 210. The oxygen stripper is configured to remove oxygen from the adduct stream 170 to provide a stripped-adduct stream 175 comprising the adduct and having a reduced oxygen content, and an oxygenated acid-gas stream 215 comprising the acid-gas and oxygen. Each of the acid-gas stream 195 or the oxygenated acid-gas stream 215 may each independently and optionally be fluidly connected to a vacuum pump intended to reduce headspace pressure within the degasser or oxygen stripper. Also shown in FIG. 2 are compressors or blowers, such as feed gas compressor 220, and acid-gas stream compressor 225. Also shown in FIG. 2 is a solvent recovery unit 230, which may be configured to recover solvent from the treated gas stream 160 and provide the recovered solvent to, for example, the reduced stream 130, and a condensate recovery unit 240, which may be configured to recover solvent from the acid-gas stream 215. Also shown in FIG. 2 is make-up stream 250 to provide additional electrolyte, electroactive species, or a component thereof, such as a solvent, as desired. By removing oxygen with the oxygen stripper or the degasser, undesired reaction with oxygen of the electroactive species, solvent, electrolyte, or components of the electrochemical cell is avoided or reduced.

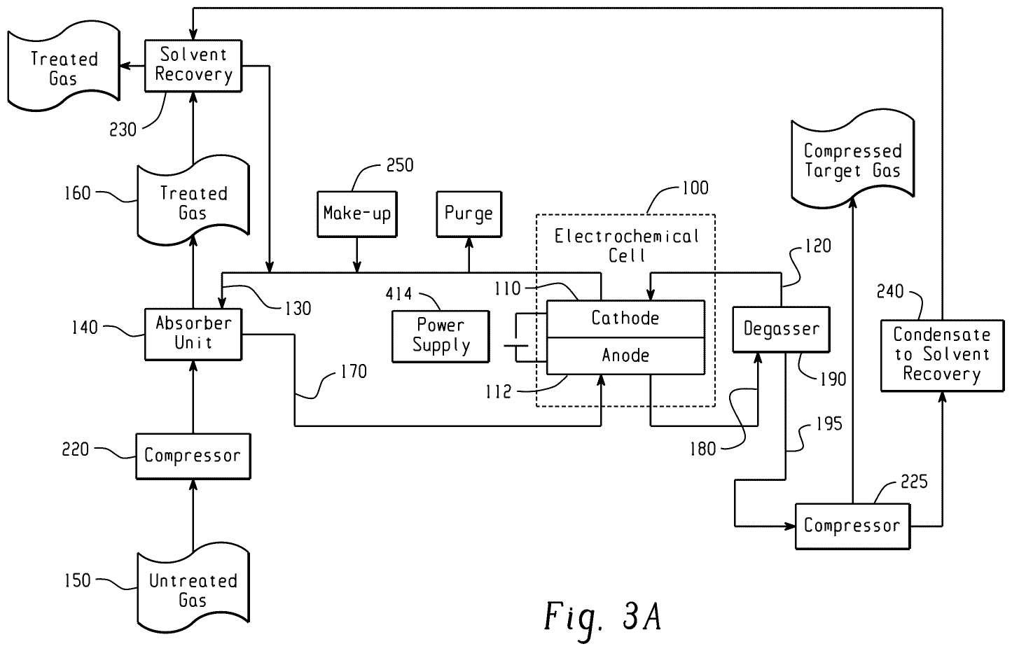

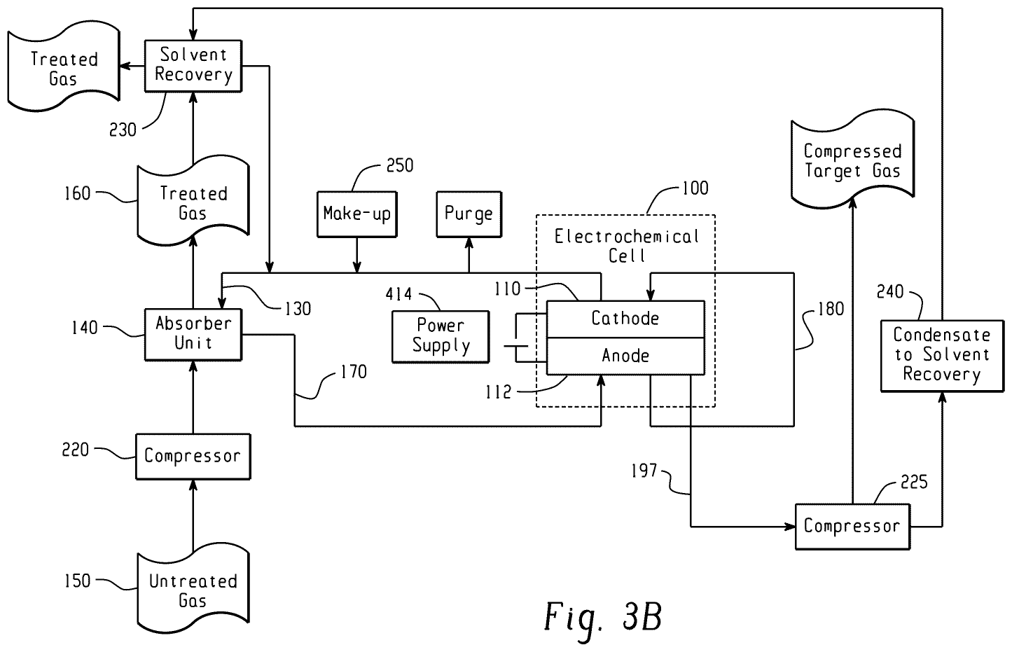

The oxygen stripper and the degasser are each optional and may be omitted if desired. As shown in FIG. 3A, the oxygen stripper may be omitted, and the adduct stream 170 may be provided to the anode 112. Also, where the oxygen stripper is omitted, the acid-gas stream 195 may be provided to the acid-gas stream compressor 225 or the condensate recovery unit 240.

The electrochemical cell 100 may be configured to remove the acid-gas and oxygen from the adduct stream, effectively integrating the function of the degasser in the electrochemical cell 100. As shown in FIG. 3B, the degasser 190 may be omitted, and the gas stream 197 may be provided from the anode 112 to the acid-gas stream compressor 225 or the condensate recovery unit 240.

The electrochemical cell may further comprise a separator 111 between the cathode and the anode. The separator may serve as a protective layer to isolate the different electrodes from one another and/or other components within the electrochemical cell. The separator may comprise a porous structure. The material for the separator may comprise for example, a cellulose membrane, a polymeric material, or a polymeric-ceramic composite material. Further examples of separators include polyvinylidene fluoride (PVDF) separators or PVDF-alumina separators. Microporous polyolefin separators, such as CELGARD, microporous polyethylene, microporous polypropylene, or multilayered microporous materials comprising polyethylene and polypropylene are mentioned. Also mentioned are ion exchange materials such as sulfonated tetrafluoroethylene fluoropolymers such as NAFION, sulfonated polystyrene cation exchange materials, layered ion exchange materials such as zirconium phosphate, or sulfonic acid functionalized polystyrene ion exchange resins such as AMBERLITE.

The cathode and the anode of the electrochemical cell can each independently comprise any suitable electrode material. The material for the cathode and the anode may each independently comprise, for example, a porous conductive carbon material such as a carbon paper, carbon felt, or carbon foam. The cathode and anode may comprise the same material, or they may comprise different materials. The cathode and anode may each independently have any suitable porosity and may comprise a porous structure. The electrochemical cell may further comprise elements to define the distance between the electrodes such as a spacer or delimiter, and may further comprise a flow distribution element or flow field to distribute feedstock and collect product fluids.

The electrochemical cell may be a multicell stack. A multicell stack comprises a plurality of electrochemical cells, 2 to 1000, 4 to 500, 10 to 250, or 20 to 125 electrochemical cells in any suitable combination of series or parallel configuration. The plurality of electrochemical cells may be arranged in a bipolar configuration or a monopolar configuration. Mentioned is a bipolar configuration. As used herein, “bipolar” refers to a configuration wherein pairs of cathodes and anodes are electrically mated together, such that the cathode of one electrochemical cell is electrically connected to the anode of the next electrochemical cell. Current collection generally occurs over an area equivalent to the geometric area of the electrochemical cell, thereby reducing ohmic losses resulting from current collection relative to when current collection occurs in a direction perpendicular to the active area of the cell, e.g., where current is carried in a perpendicular direction and through a small cross sectional area of current collecting material. In some embodiments, the plurality of electrochemical cells may be connected in series.

As used herein, “monopolar” refers to distinct anodes and cathodes, where the cathode of one electrochemical cell is adjacent to the cathode of a next electrochemical cell, and the anode of one electrochemical cell is adjacent to the anode of a next electrochemical cell. When in a monopolar configuration, a group of electrodes may be connected in parallel. Multiple electrochemical cells may be connected in parallel.

The plurality of electrochemical cells may be arranged in series or parallel. In an aspect, the plurality of electrochemical cells may be connected in series and may be configured to have a reactor potential that is applied between a cathode of an initial electrochemical cell and an anode of a final electrochemical cell, wherein the reactor potential is defined as a cell potential multiplied by n, wherein n is a number of electrochemical cells in the plurality of electrochemical cells (wherein n is 2 to 1000, preferably 4 to 500). In another aspect, the plurality of electrochemical cells may be connected in parallel and may be configured to have a same cell potential that is applied between the cathode and the anode of each electrochemical cell in the plurality of cells.

Mentioned is use of a bipolar configuration wherein pairs of cathodes and anodes arranged in a multicell stack such that the potential difference across each cathode-anode pair is established by creating a larger potential difference across the entire stack. When the electrochemical cell is a multicell stack, the streams entering the cell (for example 120 and 170 in FIG. 1) are distributed by a manifold across each of the cathodes or anodes. The distributed streams are recombined by a manifold after leaving the electrodes to form the exiting streams (for example 130 and 180 in FIG. 1). The individual cathode-anode pairs may be separated from each other by a bipolar plate, which conducts charge and does not allow the electrolyte to pass between individual cathode-anode pairs. The material for the bipolar plate may comprise a metal, for example stainless steel (e.g., 304 stainless steel, 316 stainless steel, 316L), titanium, aluminum, or carbon such as graphite, a graphite/polymer composite, or other suitable electrically conductive material.

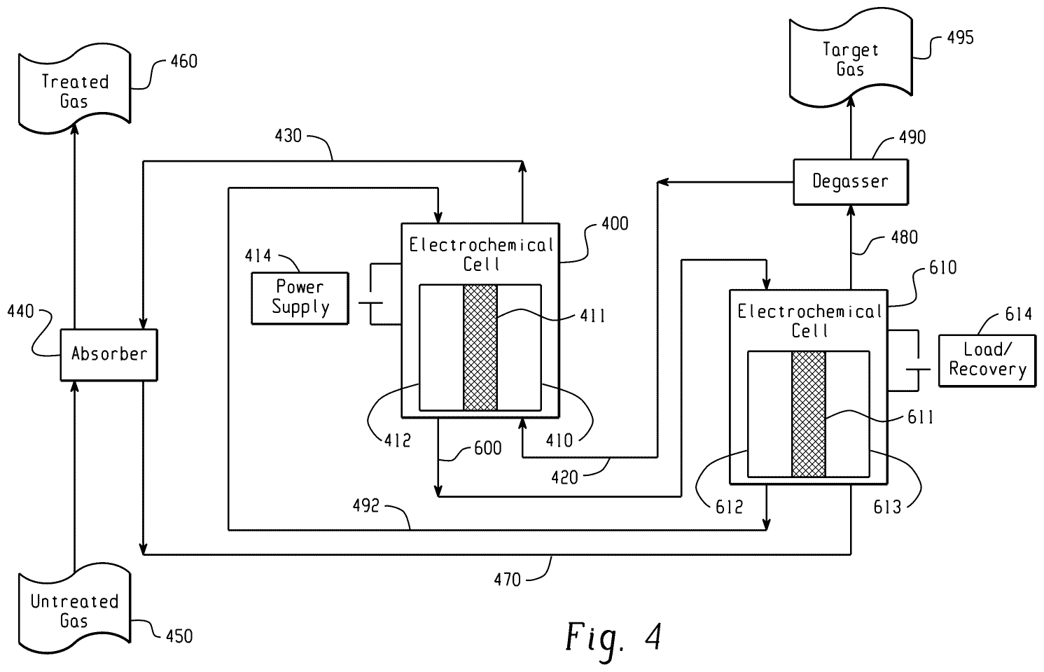

Another embodiment of the redox-flow acid-gas capture system is shown schematically in FIG. 4. The system includes an electrochemical cell 400 comprising a cathode 410 configured to contact an oxidized stream 420 comprising an electroactive species in an inactive state and provide a reduced stream 430 comprising the electroactive species in an active state. The reduced stream 430, comprising the electroactive species in an active state, is provided to an absorber 440. The absorber 440 is configured to contact an untreated gas stream 450 and the reduced stream 430 to form an adduct between the electroactive species and a Lewis-acid-gas, i.e., an acid-gas, in the untreated gas stream and a treated gas stream 460 having a reduced content of the acid-gas. The electroactive species-acid-gas adduct formed in the absorber 440 is provided by an adduct stream 470 to an anode 613 of a second electrochemical cell 610. The anode 613 is configured to contact the adduct stream 470 comprising the adduct of an electroactive species and the acid-gas, and oxidize the adduct to provide an oxidized stream 480 comprising the electroactive species in the inactive state and the acid-gas. The second electrochemical cell 610 may have a load or energy recovery device 614 to capture electrical power from the oxidation of the adduct. The load may be configured to provide 10 to 2000 A/m², based on a total cathode and anode area of the release cell. The electroactive species in the inactive state, the acid-gas, and oxygen are then treated in a degasser 490 to separate liquids and gases and provide the oxidized stream 420 comprising the electroactive species in the inactive state and an acid-gas stream 495. The acid-gas stream 495 may optionally be fluidly connected to a vacuum pump intended to reduce headspace pressure within the degasser. The oxidized stream 420 comprising the electroactive species in the inactive state is returned to a first electrochemical cell 400. The first electrochemical cell 400 may be powered by a power supply 414. The power supply may be configured to provide 10 to 2000 A/m², based on a total cathode and anode area of the release cell. The power supply may be configured to establish a potential difference of 0 to 2.0V, or 0.2 to 1.2V between the cathode and the anode of the first electrochemical cell. The system further includes a counter loop which allows for the presence of a second, complementary electroactive species. The counter loop comprises a first stream 492 which comprises the complementary electroactive species in a reduced state. The complementary electroactive species can be oxidized in the first electrochemical cell 400 which in turn facilitates reduction of the electroactive species in the first electrochemical cell 400 to its active state. The oxidized complementary electroactive species stream 600 is removed from the first electrochemical cell 400 and provided to the second electrochemical cell 610, wherein reduction of the complementary electroactive species facilitates oxidation of the adduct stream to provide the electroactive species in the inactive state. The reduced complementary electroactive species is provided back to the first electrochemical cell in a loop. Optionally, the adduct stream 470 may be provided to a stripper configured to provide a stripped-adduct stream comprising the adduct and having a reduced oxygen content. The target gas stream 495 may optionally be provided to the gas inlet of stripper unit, when present.

The system employing a single electroactive species as shown in FIG. 1 has advantages and disadvantages relative to the system employing the complementary electroactive species shown in FIG. 4. While not wanting to be bound by theory, it is understood that the symmetric system of FIG. 1 can provide improved efficiency because the oxidation of the adduct occurs in the same cell and corresponds to the reduction of the inactive species, providing effectively in-situ energy recovery and limiting energy losses, as opposed to the system having the complementary electroactive species in which two cells are used, each with its own resistance, impedance, and transport losses, and the energy cost associated with the balance of plant for the stream for the electroactive species and the stream for the complementary electroactive species.

In some aspects, the system can be configured to minimize or reduce a residence time when in contact with oxygen, e.g., to minimize a time the stream comprising the electroactive species in the active state is in the absorber or prior to treatment by the degasser or oxygen stripper by minimizing the volume of these components. The system can further comprise a pump to reduce the residence time in the absorber or downstream of the absorber and before the degasser or oxygen stripper. Also, the volume of the oxygen stripper, or a line size of any conduits may be reduced to reduce the time the electroactive species is in contact with oxygen. The pump can be configured to provide a residence time of the adduct stream in the absorber that is less than a residence time between the absorber and the anode without the pump. Additionally, the absorber itself can be designed to minimize residence time of the electroactive species in the absorber. For example, the absorber can be a rotating packed bed absorber.

As used herein, an “electroactive species” refers to an agent (e.g., a chemical entity) which has at least one reduced state and at least one oxidized state, and can be interconverted between them upon exposure to an electrical potential in an electrochemical cell. The electroactive species is capable of bonding with or binding to a target gas when the electroactive species is in a particular oxidation state, for example an active or reduced state, and releasing the target gas when the electroactive species is in a second oxidation state, for example an inactive or oxidized state. As a non-limiting example, in an aspect, the electroactive species in an inactive state can be reduced to a corresponding active state as a monoanion or dianion, which binds to the target gas forming a complex or an adduct. In some aspects, the monoanion can be the inactive state and the dianion can be the active state. Thus, the active dianion species can bind to the target gas forming a complex or an adduct, and release the target gas on oxidation to provide the inactive monoanion species.

The electroactive species in its activated state can bond with or bind to the target gas either covalently or non-covalently. In an aspect, the active or reduced state of the electroactive species can form a covalent bond to the target gas to form the adduct state. In another aspect, the activated state of the electroactive species may undergo a reaction upon exposure to the stream containing the target gas which does not involve a covalent bond to the target gas but which is sufficient to remove the target gas. For example, the activated state may be converted to its protonated form upon exposure to the stream containing the target gas. The terms “adduct” and “adduct stream” will be understood to refer either to the covalent or non-covalent association of the activated electroactive species with the target gas, or to a mixture of covalent and non-covalent associations.

Use of the neutral form, monoanion, or dianion of the electroactive species can provide an improved combination of solubility, stability, and energy efficiency. Use of species with improved solubility can be attractive to provide greater capture capacity and product purity. Use of species with improved stability and durability, in particular stability in the presence of oxygen, are desirable to avoid degradation of the electrochemically active species. Selection of the monoanion as the inactive species can, for example, provide improved solubility, improved stability (e.g., reactivity towards oxygen), improved reaction energetics, or a combination of any of the foregoing. Mentioned is an aspect in which the monoanion is the inactive species and the dianion is the active species. Also mentioned is an aspect in which the neutral species is the inactive species and the dianion is the active species. In another aspect the neutral species is the inactive species and the monoanion is the active species.

Subsequent oxidation of the electroactive species can release the target gas to provide the electroactive species in the inactive state. In particular, as a non-limiting example, if the electroactive species is benzoquinone, the neutral benzoquinone would be considered the inactive or oxidized state, the benzoquinone monoanion (i.e., a product of the addition of one electron to neutral benzoquinone) would be considered a first reduced state, and the benzoquinone dianion (the product of the addition of one electron to the monoanion) would be considered a second reduced state, either of which could be the active state.

The electroactive species of the composite can be selected such that in at least one oxidation state, the electroactive species can have a strong affinity for the target species. In an aspect, in at least one oxidation state, the electroactive species can have a binding constant with the target species of at least 10¹ liters/mole (M⁻¹), or at least 10² M⁻¹, or at least 10³ M⁻¹ at room temperature (e.g. 23° C.). Within this range, the electroactive species can have a binding constant with the target species of 10¹ to 10²⁰ M⁻¹, 10² to 10¹⁸ M⁻¹, 10³ to 10¹⁷ M⁻¹, 10³ to 10¹⁵ M⁻¹, 10³ to 10¹³ M⁻¹, or 10³ to 10¹¹ M⁻¹. In an aspect, the binding constant with the target species is 10² to 10¹⁷ M⁻¹, or 10² to 10⁷ M⁻¹. In an aspect, the target species can be carbon dioxide (CO₂), and the electroactive species (in a reduced state) can have a binding constant with the CO₂ of 10¹ to 10¹⁵. In an aspect, the target species can be sulfur dioxide (SO₂), and the electroactive species (in a reduced state) can have a binding constant with the SO₂ of 10⁵ to 10²⁰.

In an aspect, the electroactive species can have at least two oxidation states. When the electroactive species is in a first oxidation state, it can be considered to be in an “active state,” wherein the affinity for the target species can be high (e.g., the electroactive species in the “active state” can have a binding constant with the target gas as defined above). In a second oxidation state, the electroactive species can be considered to be in a “deactivated” state, wherein the affinity for the target species is reduced relative to the affinity for the target species of the “active” state. For example, the electroactive species can have a ratio of the binding constant in the deactivated state to the binding constant in the active state of 0.9:1 to 10⁻²⁰:1, for example, 0.9:1, 0.8:1, 0.5:1, 0.1:1, 10⁻²:1, 10⁻³:1, 10⁻⁴:1, or 10⁻⁵:1 to 10⁻²⁰:1. In an aspect, the binding constant with the target species in the deactivated state can be 0, that is the deactivated state is essentially inactive towards the target species.

The electroactive species can have at least one oxidation state wherein the target species can be released from the electroactive species. For example, in an aspect, the electroactive species can have at least one oxidized state, wherein upon oxidation to the oxidized state, the target species can be released from the electroactive species. In an aspect, the binding constant of the reduced electroactive species can be greater than the binding constant of the corresponding oxidized electroactive species. Accordingly, in an advantageous feature, capture and release of the target species can be achieved through redox cycling.

The electroactive species can be capable of binding the target species on a timescale on the order of minutes, on the order of seconds, on the order of milliseconds, or on the order of microseconds or less.

The electroactive species can comprise an electroactive organic compound, an electroactive polymer, an electroactive oligomer, or a combination thereof. The electroactive species can include at least one functional group capable of binding to a target species, for example a carbonyl or phenoxide group.

Exemplary electroactive organic compounds can include, but are not limited to, a substituted or unsubstituted quinone or tetrone. In an aspect, the electroactive species comprises a substituted or unsubstituted quinone (e.g., the quinone can include one or more functional groups or other moieties or linkages bound to the quinone). The choice of substituent (e.g., functional groups) on the substituted quinone can depend on a variety of factors, including but not limited to its effect on the reduction potential of the substituted quinone. One of ordinary skill, with the benefit of this disclosure, would understand how to determine which substituents or combinations of substituents on the substituted quinone are suitable for the electroactive species based on, for example, synthetic feasibility and resulting reduction potential. Exemplary functional groups can include, but are not limited to, halo (e.g., chloro, bromo, iodo), hydroxyl, carboxylate/carboxylic acid, sulfonate/sulfonic acid, alkylsulfonate/alkylsulfonic acid (e.g., C₁₋₁₈ alkylsulfonate), phosphonate/phosphonic acid, alkylphosphonate/alkylphosphonic acid (e.g., C₁₋₁₈ alkylphosphonate), acyl (e.g., acetyl or ethyl ester), amino, amido, quaternary ammonium (e.g., tetraalkylamino), branched or unbranched alkyl (e.g., C₁₋₁₈ alkyl), heteroalkyl, alkoxy, glycoxy, polyalkyleneglycoxy (e.g., polyethyleneglycoxy), imino, polyimino, branched or unbranched alkenyl (e.g., C₂₋₁₈ alkenyl), branched or unbranched, C₂₋₁₈ alkynyl, C₆₋₃₀ aryl, C₂₋₂₀ heteroaryl, heterocyclyl, nitro, nitrile, thiyl, or carbonyl groups, any of which can be substituted or unsubstituted. Any suitable organic or inorganic counterion can be present in the foregoing charged species, for example an alkali metal, alkaline earth metal, ammonium, or a substituted ammonium of the formula R₄N⁺ wherein each R is the same or different, and is independently a C₁₋₁₈ hydrocarbyl, provided that at least one R is hydrocarbyl.

In an aspect, the electroactive species comprises a substituted or unsubstituted quinone of structure (I) or (II):

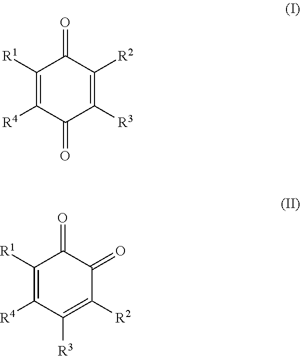

wherein R¹, R², R³, and R⁴ are independently at each occurrence hydrogen, halogen (e.g., chloro, bromo, iodo), hydroxyl, carboxylate/carboxylic acid, sulfonate/sulfonic acid, alkylsulfonate/alkylsulfonic acid (e.g., C₁₋₁₈ alkylsulfonate), phosphonate/phosphonic acid, alkylphosphonate/alkylphosphonic acid (e.g., C₁₋₁₈ alkylphosphonate), acyl (e.g., acetyl or ethyl ester), amino, amido, quaternary ammonium (e.g., tetraalkylamino), branched or unbranched C₁₋₁₈ alkyl, C₁₋₁₈ heteroalkyl, C₁₋₁₈ alkoxy, glycoxy, polyalkyleneglycoxy (e.g., polyethyleneglycoxy), imino, polyimino, branched or unbranched alkenyl, branched or unbranched C₂₋₁₈ alkynyl, C₆₋₂₀ aryl, C₂₋₂₀ heteroaryl, heterocyclyl, nitro, nitrile, thiyl, or carbonyl groups, any of which can be substituted or unsubstituted, and any two adjacent R¹-R⁴ groups can optionally join together to form a cyclic group.

In an aspect, the electroactive organic compound can comprise a quinone, here defined as a cyclic, conjugated system having an even number of carbonyl groups that can be reduced in the manner shown below to form the corresponding aromatic species.

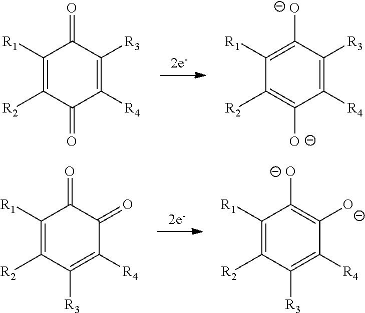

These include derivatives of 1,4-benzoquinone, 1,2-benzoquinone, naphthoquinone, anthraquinone, phenanthrenequinone, benzanthraquinone, dibenzoanthraquinone, 4,5,9,10-pyrenetetrone, or a combination thereof. Any of the foregoing can optionally be substituted as described above. In an aspect, the electroactive organic compound is a substituted or unsubstituted 1,4-benzoquinone. Other regioisomers of the foregoing non-limiting exemplary electroactive organic compounds can also be used (e.g., with substituents at different positions of the quinone).

In an aspect, the electroactive species comprises the electroactive polymer. As used herein, the term “polymer” refers to structures having greater than 10 repeating units. For example, an electroactive polymer can comprise repeating units including any of the foregoing electroactive organic compounds. Suitable electroactive polymers can include, for example, those comprising repeating units derived from a substituted or unsubstituted quinone. In an aspect, at least a portion of the electroactive polymer comprises a polymer backbone wherein at least one of the electroactive organic compounds is covalently bound to the polymer backbone. In an aspect, the electroactive organic compounds can form at least a portion of the polymer backbone.

In an aspect, the electroactive polymer comprises repeating units derived from a substituted or unsubstituted quinone, which as described above can include 1,4-benzoquinone, 1,2-benzoquinone, naphthoquinone, anthraquinone, phenanthrenequinone, benzanthraquinone, dibenzoanthraquinone, 4,5,9,10-pyrenetetrone, or a combination thereof.

In an aspect, the electroactive species comprises the electroactive oligomer. As used herein, the term “oligomer” refers to structures having 2 to 10 repeating units. The electroactive oligomer can accordingly have any structure as described for the electroactive polymer, except that it is limited to 10 repeat units or less. For example, suitable electroactive oligomers can include those comprising repeating units derived from a substituted or unsubstituted quinone, preferably an oligomer comprising repeating units derived from 1,4-benzoquinone, 1,2-benzoquinone, naphthoquinone, anthraquinone, phenanthrenequinone, benzanthraquinone, dibenzoanthraquinone, 4,5,9,10-pyrenetetrone, or a combination thereof.

In an aspect, the electroactive species can be a quinone-containing poly(arylene) comprising repeating units of at least one of formulas (I) to (VI)

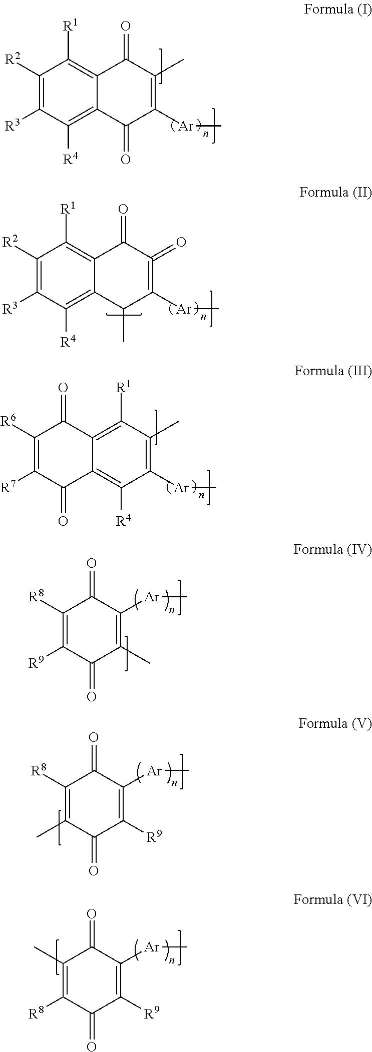

wherein R¹, R², R³, R⁴, R⁶ and R⁷ are independently at each occurrence hydrogen, halogen, a C₁₋₃₀ alkyl group, a C₁₋₃₀ alkoxy group, a poly(C₁₋₃₀ alkylene oxide) group; a C₃₋₃₀ cycloalkyl group, a C₃₋₃₀ branched alkyl group, a C₆₋₃₀ aryl group, a C₂₋₃₀ heteroaryl group, a C₁₋₃₀ fluoroalkyl group, heterocyclyl, a nitrile group, a nitro group, a hydroxyl group, a carboxylic acid group, a thiol group, or a vinyl group; R⁸ and R⁹ are independently at each occurrence hydrogen, halogen, a C₁₋₃₀ alkyl group, a C₁₋₃₀ alkoxy group, a poly(C₁₋₃₀ alkylene oxide) group; a C₃₋₃₀ cycloalkyl group, a C₃₋₃₀ branched alkyl group, a C₆₋₃₀ aryl group, a C₂₋₃₀ heteroaryl group, a C₁₋₃₀ fluoroalkyl group, heterocyclyl, a nitrile group, a nitro group, a hydroxyl group, a carboxylic acid group, a thiol group, or a vinyl group; and Ar is a substituted or unsubstituted C₆₋₂₀ arylene group, preferably a substituted or unsubstituted phenylene group or a substituted or unsubstituted 9,9-di(C₁₋₁₂ alkyl) fluorene group. Such quinone-containing poly(arylene) s can be as further disclosed in U.S. patent application Ser. No. 17/470,632, the contents of which are hereby incorporated herein by reference in their entirety for all purposes.

In an aspect, the electroactive species can be a quinone-containing polymer comprises repeating units of at least one of Formulas (VII) to (X) or a hydrogenated derivative thereof

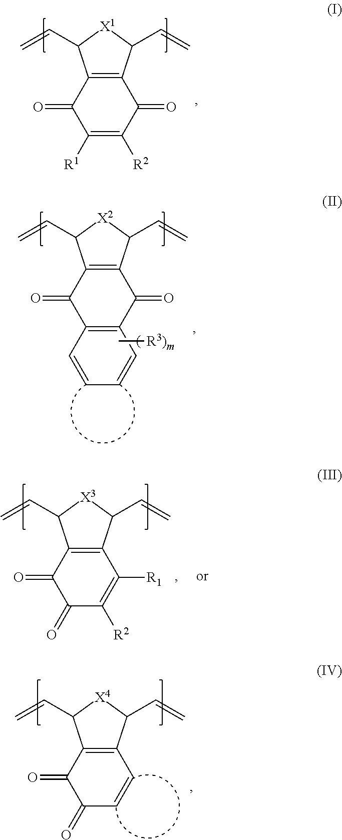

wherein in Formulas (VII) to (X), X¹ is —CH₂— or —O—; X² is —CH₂— or —O—; X³ is —CH₂— or —O—; X⁴ is —CH₂— or —O—; R¹ and R² are independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group; R³ is independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, or a thiol group, an amine group, an amide group, an ester group, or a ketone group; m is 2 to 4; and the dashed lines of Formulas (II) and (IV) indicate the optional presence of one or more additional fused substituted or unsubstituted aryl groups; provided that when X¹ is —CH₂—, at least one of R¹ and R² is not hydrogen. Such quinone-containing polymers can be as further disclosed in U.S. patent application Ser. No. 18/712,366, the contents of which are hereby incorporated herein by reference in their entirety for all purposes.

In an aspect, the electroactive species can be an electroactive polymer comprising repeating units of Formula (XI)

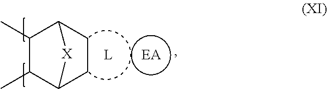

wherein X is —CH₂— or —O—; L is an optional fused C₄₋₆ cycloalkyl linking group or an optional fused benzene linking group; and EA is an electroactive species having an oxidized state, and at least one reduced state. Such electroactive polymers can be as further described in International Patent Application No. PCT/US24/29865, the contents of which are hereby incorporated herein by reference in their entirety for all purposes.

When present, the complementary electroactive species can be the same or different in composition or structure from the electroactive species. It will be understood that when the complementary electroactive species is the same as the electroactive species, the electroactive species may be in a different oxidation state than the complementary electroactive species in the electrochemical cell or, when present, the release cell. In an aspect, the complementary electroactive species is different from the electroactive species. In an aspect, the complementary electroactive species can be an electroactive organic molecule, an electroactive polymer, or an electroactive oligomer, as previously described, or an electroactive inorganic complex, an electroactive metallocene, or a combination comprising any of the foregoing.

In an aspect, the complementary electroactive species can be an electroactive inorganic complex, for example an alkali metal-transition metal oxide or an alkali metal-transition metal phosphate of the formula

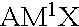

wherein A is Li, Na, or K; M¹ is Ni, Co, Mn, Al, Ti, Mo, Fe, V, Si, or a combination thereof; and X is O₂ or PO₄. In an aspect, the electroactive species can be LiFePO₄.

In an aspect, the complementary electroactive species comprises a metallocene. An example of a suitable metallocene can include, but is not limited to, ferrocene, or a polymer comprising repeating units derived from ferrocene (e.g., polyvinyl ferrocene), or derivatives thereof.

In an aspect, the complementary electroactive species comprises a MXene. MXene, as used herein, refers to materials comprising metal carbides, anitrides, carbonitrides, or a combination thereof.

During operation of the electrochemical cell, the complementary electroactive species can serve as a source of electrons for the reduction of the electroactive active species Likewise, the complementary electroactive species can serve as a sink for electrons during the oxidation of the electroactive species in the release cell.

The electroactive species is reactive toward a target gas, also referred to herein as a Lewis acid-gas or an acid-gas. The target gas is an electrophilic molecule. In an aspect, the target gas is a Lewis acid-gas. The target gas is capable of forming a complex or an adduct with the electroactive species of the composite when the electroactive species is in a reduced state, for example, by bonding to the electroactive species in its reduced state. The target gas can comprise carbon dioxide (CO₂), a sulfur oxide species such as sulfur dioxide (SO₂) or sulfur trioxide (SO₃), an organosulfate (R²SO₄, where each R is independently hydrogen, C₁₋₁₂ alkyl, or C₆₋₂₀ aryl) such as dimethyl sulfate, a nitrogen oxide species such as nitrogen dioxide (NO₂) or nitrogen trioxide (NO₃), a phosphate ester (R³PO₄, where each R is independently hydrogen, C₁₋₁₂ alkyl, or C₆₋₂₀ aryl) such as trimethyl phosphate, an ester (RCOOR′ where each R is independently hydrogen, C₁₋₁₂ alkyl, or C₆₋₂₀ aryl, and each R′ is independently C₁₋₁₂ alkyl or C₆₋₂₀ aryl) such as methyl formate or methyl acrylate, an aldehyde (RCHO, where each R is independently hydrogen, C₁₋₁₂ alkyl, or C₆₋₂₀ aryl) such as formaldehyde or acrolein, a ketone (R²CO, where each R is independently hydrogen, C₁₋₁₂ alkyl, or C₆₋₂₀ aryl) such as acetone, an isocyanate (RNCO, where each R is independently hydrogen, C₁₋₁₂ alkyl, or C₆₋₂₀ aryl, and each R′ is independently C₁₋₁₂ alkyl or C₆₋₂₀ aryl) such as methyl isocyanate, isothiocyanate (RNCS, where each R is independently hydrogen, C₁₋₁₂ alkyl, or C₆₋₂₀ aryl, and each R′ is independently C₁₋₁₂ alkyl or C₆₋₂₀ aryl), a borane (BR₃, where each R is independently hydrogen, C₁₋₁₂ alkyl, or C₆₋₂₀ aryl) such as trimethyl borane, or a borate (R³BO₃, where each R is independently hydrogen, C₁₋₁₂ alkyl, or C₆₋₂₀ aryl) such as trimethyl borate. The target gas can optionally comprise a combination of any of the foregoing target gas species.

The various streams may comprise an electrolyte. The electrolyte can include a liquid electrolyte, an ionic liquid, or any other suitable electrolyte or combination of electrolytes. The liquid electrolyte may be a solution comprising at least one salt and at least one organic solvent, and may further comprise water. The liquid electrolyte may be a solution comprising at least one salt and water, without an organic solvent. In some aspects, the liquid electrolyte may be devoid of organic solvent. The salt comprises a cation and an anion. Representative cations include sulfonium, phosphonium, ammonium, or piperidinium cations. S(CH₃)₃⁺, N(R⁴)⁺ where R is a C1 to C4 alkyl group such as N(CH₃)₄⁺ or NH₃(C₂H₅), NH₄⁺, C₁₉H₁₅⁺, C₆H₅CH₂N(CH₃)₃⁺, Li⁺, Na⁺, K⁺, Ca²⁺, Ba²⁺, or C₅H₅NH⁺ (pyridinium ion), or a combination thereof. Representative anions include BF₄⁻, PF₆⁻, AsF₆⁻, SbF₆⁻, AlCl₄⁻, HSO₄⁻, ClO₄⁻, CH₃SO₃⁻, CF₃CO₂⁻, (CF₃SO₂)₂N⁻, Cl⁻, Br⁻, I⁻, SO₄⁻, CF₃SO₃⁻, (C₂F₅SO₂)₂N⁻, (C₂F₅SO₂)(CF₃SO₂)N—, NO₃⁻, Al₂Cl₇⁻, CF₃COO⁻, CH₃COO⁻, CF₃SO₃⁻, (CF₃SO₂)₃C⁻, (CF₃CF₂SO₂)₂N⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂ (CF₃)₂CO⁻, (CF₃SO₂)₂CH⁻, (SF₅)₃C⁻, (O(CF₃)₂C₂ (CF₃)₂O)₂PO⁻, (CF₃SO₂)₂N⁻, or a combination thereof. The organic solvent may comprise an ether solvent, a carbonate solvent, a sulfone solvent, a sulfoxide solvent, an ester solvent, a phosphate ester solvent, or a ketone solvent. For example, the organic solvent may include at least one of propylene carbonate, ethylene carbonate, fluoroethylene carbonate, vinylethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyl tetrahydrofuran, γ-butyrolactone, dioxorane, 4-methyldioxorane, dimethyl acetamide, dimethylsulfoxide, sulfolane, triethyl phosphate, trioctyl phosphate, dioxane, 1,2-dimethoxyethane, sulfolane, dichloroethane, chlorobenzene, nitrobenzene, succinonitrile, diethylene glycol dimethyl ether (DEGDME), tetraethylene glycol dimethyl ether (TEGDME), polyethylene glycol dimethyl ether (PEGDME, Mn=about 500), dimethyl ether, diethyl ether, dibutyl ether, dimethoxyethane, 2-methyl tetrahydrofuran, or tetrahydrofuran. However, the disclosed embodiment is not limited thereto. Any suitable organic solvent or mixture of organic solvents may be used.

The ionic liquid, if present, includes an anion component and a cation component. The anion of the ionic liquid can include, but is not limited to, one or more of halide, sulfate, sulfonate, carbonate, bicarbonate, phosphate, nitrate, nitrate, acetate, PF₆, BF₄, trifluoromethanesulfonate (triflate), nonaflate, bis(trifluoromethylsulfonyl)amide, trifluoroacetate, heptafluororobutanoate, haloaluminate, triazolide, or an amino acid derivative (e.g., proline with the proton on the nitrogen removed). The cation of the ionic liquid can include, but is not limited to, one or more of imidazolium, pyridinium, pyrrolidinium, phosphonium, ammonium, sulfonium, thiazolium, pyrazolium, piperidinium, triazolium, pyrazolium, oxazolium, guanidinium, an alkali cation, or dialkylmorpholinium. In an aspect, the room temperature ionic liquid includes an imidazolium as a cation component. In an aspect, the room temperature ionic liquid includes 1-butyl-3-methylimidazolium (“BMIM”) as a cation component. In an aspect, the room temperature ionic liquid includes bis(trifluoromethyl-sulfonyl)imide (“TFSI”) as an anion component. In an aspect, the room temperature ionic liquid includes 1-butyl-3-methylimidazolium bis(trifluoromethylsulfonyl)-imide (“[BMIM][TFSI]”). In an aspect, the room temperature ionic liquid includes 1-butyl-3-methylimidazolium tetrafluoroborate (“BF₄”) (“[BMIM][BF₄]”).

In an aspect, the electrolyte includes an ionic liquid that may include an unsubstituted or substituted imidazolium, an unsubstituted or substituted morpholinium, unsubstituted or substituted pyridinium, an unsubstituted or substituted pyrrolidinium, an unsubstituted or substituted piperidinium, an unsubstituted or substituted piperazinium, an unsubstituted or substituted pyrazinium, or a combination thereof. In a particular aspect, the ionic liquid may be 1-ethyl-3-methylimidazolium bis(trifluoromethanesulfonyl)imide, 1-ethyl-3-methylimidazolium bis(fluorosulfonyl)imide, 1-ethyl-3-methylimidazolium bis(pentafluorosulfonyl)imide, 1-ethyl-3-methylimidazolium dicyanamide, 1-ethyl-3-methylimidazolium tetrafluoroborate, 1-butyl-3-methylimidazolium bis(trifluoromethylsulfonyl)imide, 1-butyl-3-methylpyridinium bis(trifluoromethyl-sulfonyl)imide, N-methyl-N-propylpiperidinium bis(trifluoromethanesulfonyl)imide, or a combination thereof.

The absorber is configured to contact the reduced stream comprising the electroactive species in the active state and the acid-gas and form the adduct stream. Thus in an aspect, the absorber can comprise a feed gas inlet, a feed gas outlet, a reduced stream inlet in fluid communication with the cathode of the electrochemical cell, and an adduct stream outlet, where the adduct stream is in fluid communication with the electrochemical cell (as in FIG. 1) or the release cell (as in FIG. 4).

The absorber can generally be any vessel capable of receiving the reduced stream and the untreated gas stream to form the adduct between the electroactive species and a Lewis acid-gas. For example, the absorber can be a column (e.g., a packed column, a bubble column, a spray column, a plate column, a wetted-wall column, or the like), a tank, or a stirred vessel such as a mechanically agitated contactor.

The degasser can be configured to separate the oxidized stream, specifically to separate gasses (e.g., the acid-gas, oxygen) from a liquid stream comprising the electroactive species in the inactive state. In some aspects, the degasser unit can be configured to reduce the oxygen content of the oxidized stream and provide a stream comprising the electroactive species in an inactive state and having an oxygen content less than the oxygen content of the oxidized stream. Representative degassers include a flash drum separator, a membrane degasser, inert gas sparging, or a vacuum degasser. The degasification can be by, for example, pressure degassing, thermal degassing, membrane degasification, ultrasonic degassing, or sparging with inert gas. Pressure degassing may be accomplished by, for example, connection of a vacuum pump to the gas outlet of the degasser. The vacuum pump may be used to create a headspace pressure in the degasser of less than 1 atmosphere (atm), or less than 0.6 atm. The oxidized liquid stream removed from the degasser unit has a total gas concentration that is less than the total gas concentration of the oxidized stream that enters the degasser.

In some aspects the adduct stream removed from the absorber can be further provided to an oxygen stripper. The oxygen stripper can be configured to reduce the oxygen content of the adduct stream. The oxygen stripper can comprise an adduct stream inlet and an adduct stream outlet and a gas inlet and outlet. In an aspect, the adduct stream inlet of the oxygen stripper is in fluid communication with an outlet of the absorber. The adduct stream outlet of the oxygen stripper is in fluid communication with the anode. In some aspects the gas stream removed from the degasser can be further provided to an oxygen stripper, for example as shown in FIG. 2.

In an aspect, the feed that is conveyed to the oxygen stripper can be contacted with a stripping gas, which has a lower (e.g., substantially zero) oxygen concentration than the liquid stream, to remove residual dissolved oxygen from the stream. The removed oxygen can be passed out of the oxygen stripper via an overhead vapor stream comprising the stripping gas and the oxygen. In some aspects, the product gas (i.e., acid-gas released from the adduct) can be used as the stripping gas. The stripped stream can be removed from the oxygen stripper, and optionally heated to remove any residual dissolved stripping gas. Other degasification processes, including for example pressure degassing, thermal degassing, membrane degasification, or ultrasonic degassing may also be used in the oxygen stripper to remove residual oxygen. Pressure degassing may be accomplished by, for example, connection of a vacuum pump to the gas outlet of the stripper. The vacuum pump may be used to create a headspace pressure in the stripper of less than 1 atmosphere (atm), or less than 0.6 atm.

Another aspect of the present disclosure is a method of separating a target gas from a fluid mixture. The method comprises providing the fluid mixture comprising the target gas to the system according to any of the embodiments described herein to obtain a purified fluid mixture. After providing the fluid mixture to the system, the provided purified fluid mixture has a concentration of the target gas that is lower than an initial concentration of the target gas in the fluid mixture prior to providing it to the system. In an advantageous aspect, the method can be a continuous method. The fluid mixture, which can also be referred to as an input gas, can be, for example, ambient air (e.g., air from an ambient environment, such as outdoor air). In an aspect, the gas separation system can be used for direct air capture. The systems and methods described herein can be useful for removing a target gas such as carbon dioxide directly from ambient air (e.g., to reduce greenhouse gas levels), without the need for any pre-concentration step. Certain aspects of the present disclosure can make the systems and methods described herein particularly useful for direct air capture (e.g., an ability to bond with a target gas while being thermodynamically disfavored from reacting with major components of ambient air, such as oxygen).

In an aspect the amount of target gas in a treated gas mixture (e.g., a gas mixture from which an amount of the target gas is removed upon being exposed to the system according to the present disclosure) is less than or equal to 50%, less than or equal to 25%, less than or equal to 10%, less than or equal to 5%, less than or equal to 2%, less than or equal to 1%, less than or equal to 0.5%, less than or equal to 0.1% of the amount (in volume percent) of the target gas in the original gas mixture prior to treatment (e.g., the amount of the target in the gas mixture prior to being exposed to the system according to the present disclosure). In an aspect, the amount of target gas in a treated gas mixture is greater than or equal to 0.001%, greater than 0.005%, greater than or equal to 0.01%, greater than or equal to 0.05%, greater than or equal to 0.1%, greater than or equal to 0.5%, greater than or equal to 1%, greater than or equal to 2%, greater than or equal to 5% of the amount (in volume percent) of the target gas in the original gas mixture prior to treatment. In an aspect, the concentration of the target gas in the gas mixture is relatively low, for example when the gas mixture is ambient air. For example, the concentration of the target gas in the gas mixture prior to exposure to the system according to the present disclosure can be less than or equal to 500 ppm, or less than or equal to 450 ppm, or less than or equal to 400 ppm, or less than or equal to 350 ppm, or less than or equal to 300 ppm, or less than or equal to 200 ppm.

In an aspect, the fluid mixture (e.g., input gas mixture) is ventilated air. The ventilated air can be air in an enclosed or at least partially enclosed place (e.g., air being circulated in an enclosed place). Examples of places in which the gas mixture (e.g., ventilated air) can be located include, but are not limited to sealed buildings, partially ventilated places, car cabins, inhabited submersibles, air crafts, medical and personal ventilation devices, and the like.

The concentration of target gas in the ventilated air can be higher than ambient air but lower than concentrations typical for industrial processes. In an aspect, the concentration of the target gas in the gas mixture prior to exposure to the system of the present disclosure is less than or equal to 5,000 ppm, or less than or equal to 4,000 ppm, or less than or equal to 2,000 ppm, or less than or equal to 1,000 ppm. In an aspect, the concentration of the target gas in the gas mixture (e.g., when it is ventilated air or air in enclosed spaces) is as low as 1,000 ppm, or as low as 800 ppm, or as low as 400 ppm.

In some aspects, the fluid mixture can have a relatively high concentration of oxygen gas (e.g., prior to exposure to the system). In an aspect, oxygen gas is present in the gas mixture (e.g., prior to exposure to the system) at a concentration of greater than or equal to 0 vol %, or greater than or equal to 0.1 vol %, or greater than or equal to 1 vol %, or greater than or equal to 2 vol %, or greater than or equal to 5 vol %, or greater than or equal to 10 vol %, or greater than or equal to 20 vol %, or greater than or equal to 50 vol %, or greater than or equal to 75 vol %, or greater than or equal to 90 vol %, greater than or equal to 95 vol %. In an aspect, oxygen gas is present in the gas mixture at a concentration of less than or equal to 99 vol %, or less than or equal to 95 vol %, or less than or equal to 90 vol %, or less than or equal to 75 vol %, or less than or equal to 50 vol %, or less than or equal to 25 vol %, or less than or equal to 21 vol %, or less than or equal to 10 vol %, or less than or equal to 5 vol %, or less than or equal to 2 vol %. Advantageously, the oxygen concentration of the adduct stream can be reduced by one or both of the oxygen stripper or the degasser to provide an acceptably low level of oxygen, such that the initial presence of oxygen does not interfere with the desired capture and release of the target gas.

The systems and methods described herein can be implemented in a variety of applications. The following aspects provide several non-limiting examples of applications. In an aspect, the systems and methods described herein can be for removing a target gas (e.g., CO₂) from ambient air, as well as enclosed spaces such as airtight building, car cabins—reducing the heating cost of incoming air for ventilation—and submarines and space capsules, where an increase in CO₂ levels could be catastrophic. In aspects directed to the electrical power industry, they can be used for capturing carbon dioxide post-combustion at varying concentrations. In an aspect, the systems and methods are suitable for separating target gases from industrial flue gas or industrial process gas. Also, they can be used for capturing sulfur dioxide and other gases from flue gas. In aspects directed to the oil and gas industry, the disclosed systems and methods can be used for capturing carbon dioxide and other gases from various processes and diverting them for downstream compression or processing. The disclosed systems and methods can be applied to capture carbon dioxide from burning natural gas used to heat the greenhouses in mild and cold climates, then diverting the captured dioxide into the greenhouse for the plants to use in photosynthesis, i.e., to feed the plants.

Thus, the systems described herein represent a significant improvement, particularly with regard to improved gas separation systems.

### EXAMPLES

### Example 1

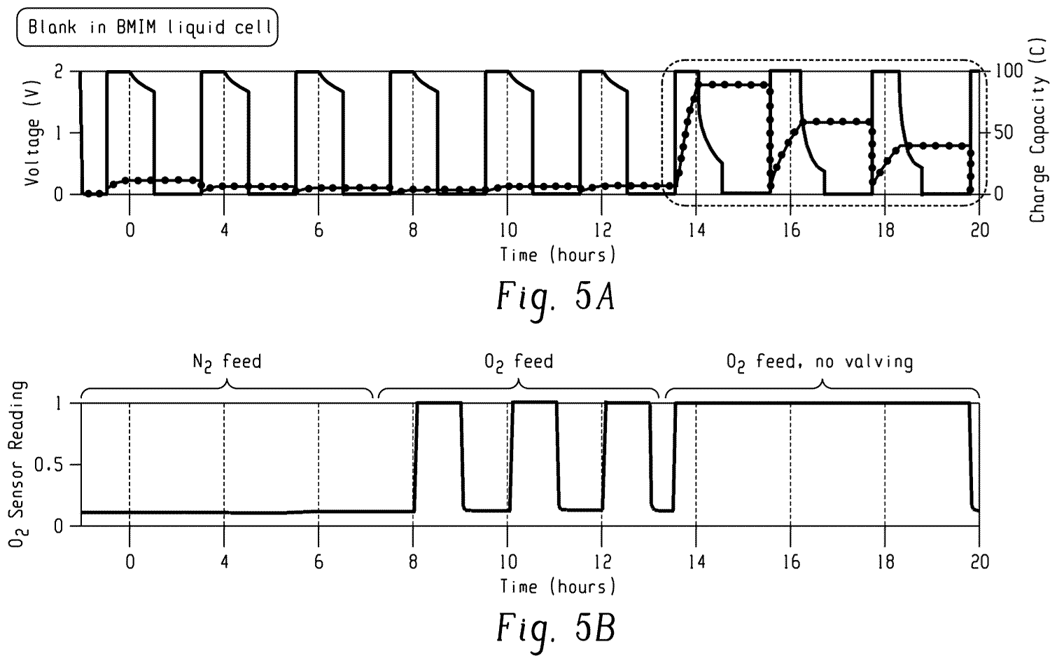

An electrochemical cell was built using a 25 cm² square piece of CELLTECH GF030 carbon felt as the working electrode, three layers of CELGARD 3401 as separator, stainless steel endplates, and EPDM gasketing for liquid sealing; the counter electrode was made using a 25 cm² square piece of 17 gsm carbon fiber paper coated in poly-(4-vinylbenzyl-1-ferrocenoate). The working compartment of the cell was connected via FEP tubing to a peristaltic pump and a 100 mL round-bottom flask (“the reservoir”), using three-way valves connected with additional FEP tubing as a bypass line such that the liquid flow could be made either to enter the electrochemical cell or to bypass it. 1-Butyl-3-methylimidazolium bis(trifluoromethylsulfonyl)imide (50 mL) was introduced into the reservoir, and circulated through the system at a flow rate of 10 mL min⁻¹ using the pump. The reservoir was equipped with a gas inlet needle positioned below the level of the liquid and having a three-way valve such that the incoming gas flow could be readily switched between N₂ and air. It was also equipped with a gas outlet which flowed into an O₂ sensor, the reading from which is shown in FIG. 5B. The electrolyte was sparged with 100 sccm N₂ while circulating for 2 hours, and then the cycling experiments shown in FIGS. 5A and 5B were begun.

The first six cycles (0-13 hours in FIGS. 5A and 5B) consisted of A) charging the electrochemical cell at a potential of −2.0 V, with valves set to direct liquid flow into the electrochemical cell; B) holding the electrochemical cell at open circuit potential, with valves set to direct liquid flow to bypass the electrochemical cell; C) discharging the electrochemical cell at a potential of 0 V, with valves set to direct liquid flow into the electrochemical cell. During the first three cycles, the inlet gas to the reservoir was 100 sccm N₂ during all three steps. As FIG. 5A shows, the charge capacity of each charge cycle was low (approximately 10 C in each case), corresponding to capacitive charging of the working electrode. During the second three cycles, the feed gas was changed to 100 sccm air during step B, then returned to 100 sccm N₂ during step C. FIG. 5A shows that the charge capacity for these three cycles (again approximately 10 C in each case) is not increased as compared to the first three cycles, illustrating the effectiveness of degassing at avoiding electrochemical reaction with oxygen. During the last three cycles, step B was performed with the liquid flow path open to the electrochemical cell, and the sparging gas was 100 sccm air during all steps. The large excess charge capacity of these three cycles as compared to the first six cycles reflects the electrochemical oxygen reactivity that takes place in the absence of effective degassing.

### Example 2

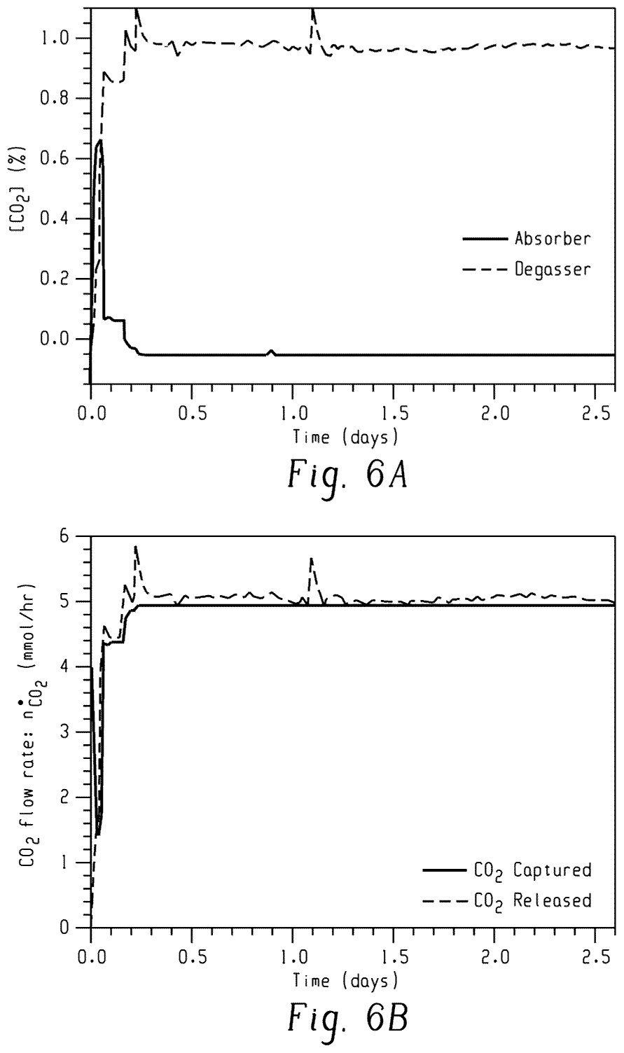

A continuously circulating acid-gas capture device of the type described in FIG. 2 was successfully operated for more than two days without interruption; the results are shown in FIGS. 6A and 6B. A device matching the design in FIG. 2 was built using 3/16 inch inner diameter stainless steel tubing to connect the absorber, degasser, and gas stripper elements, each of which was a glass tube of height 12 inches and inner diameter 2 inches filled with PRO-PAK 0.16 inch stainless steel random packing. Peristaltic pumps were connected between each element as shown in FIG. 2. An electrochemical cell was built using 35 cm² square pieces of AvCarb G475A soft carbon felt as both cathode and anode, three layers of CELGARD 3401 as separator, 316L stainless steel current collectors, aluminum endplates, and EPDM gasketing for liquid sealing. The electrochemical cell was connected to the system as shown in FIG. 2. Into the system was introduced 500 mL of a DMSO solution of 100 mM tetrabutylammonium hexafluorophosphate and 30 mM of a heterocycle-fused benzoquinone as the electroactive species as an equimolar mixture of the dianion and monoanion forms. The peristaltic pumps were used to circulate the liquid at a flowrate of 11 mL min⁻¹, and the cell was polarized to a constant current of 175 mA. A feed gas stream of 1% CO₂ in N₂ was introduced into the absorber column at a rate of 200 sccm, and a stream of N₂ was introduced into the degasser column at 200 sccm. FIG. 6A shows the readings from flow-through CO₂ sensors positioned downstream of the absorber (solid line) and degasser (dashed line), showing that across 60 hours of operation essentially all incoming CO₂ is captured by the active material in the absorber (near-zero CO₂ concentration in the gas stream leaving the absorber) and a corresponding amount of CO₂ is released and enters the gas phase in the degasser. FIG. 6B converts these results to a molar CO₂ capture rate (solid line) and release rate (dashed line), highlighting their close correspondence and stability across 60 hours of operation.

### Example 3

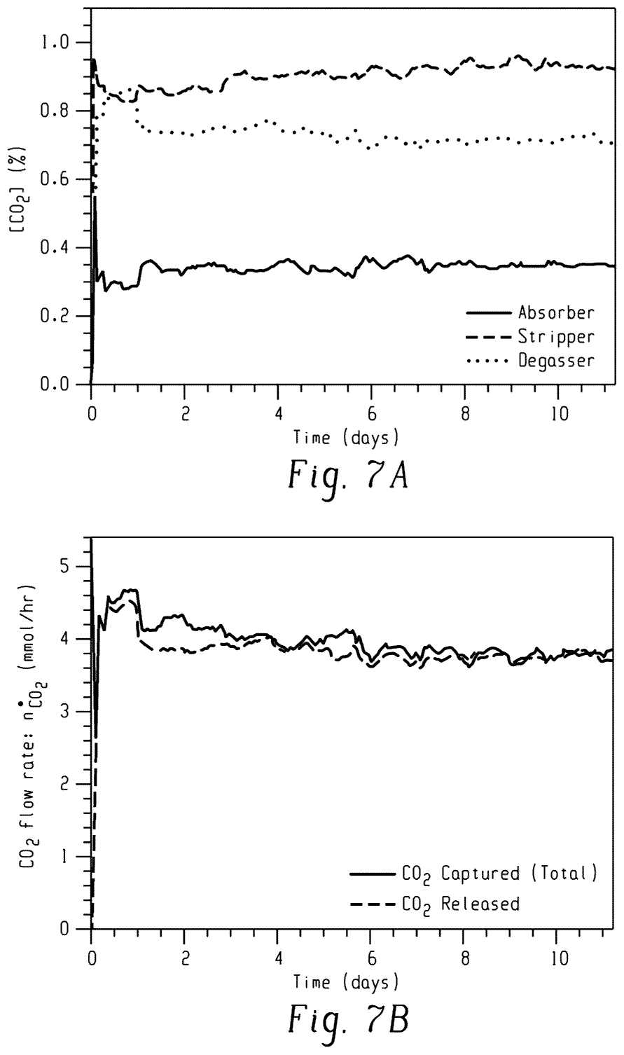

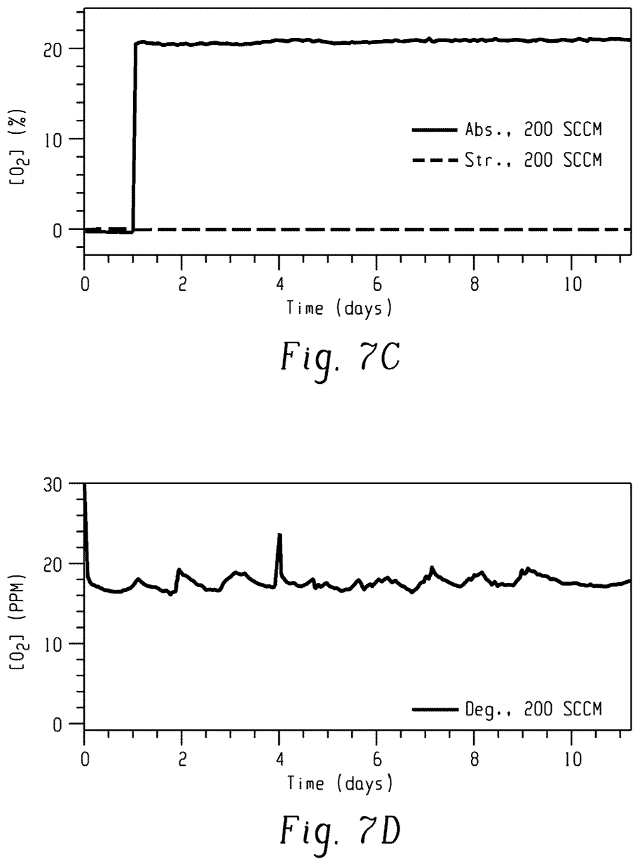

A continuously circulating device of identical construction to that described in the prior Example 2 was constructed for the purpose of demonstrating the redox flow acid-gas capture system. An electrochemical cell, comprising of AvCarb G475A soft carbon felt as both cathode and anode, three layers of CELGARD 3401 as separator, 316L stainless steel current collectors, aluminum endplates, and EPDM gasketing for liquid sealing was used to regenerate and deactivate the electroactive sorbent. To this was added approximately 650 mL of a DMSO solution of 100 mM tetrabutylammonium hexafluorophosphate and 30 mM of a functionalized benzoquinone as the electroactive species as an equimolar mixture of the dianion and monoanion forms. The peristaltic pumps were used to circulate the liquid at a flowrate of 16 mL min⁻¹, and the cell was polarized using a constant voltage across a single cell of 0.7V. To the absorber column, a feed gas stream of approximate molar composition 1% CO₂ and 99% N₂ was introduced at a constant mass flow rate of 200 SCCM. After approximately one day of operation, the feed stream to the absorber was changed to 1% CO₂, 78% N₂, and 21% O₂. To the O₂ stripper column, a feed gas stream of approximate molar composition 1% CO₂ and 99% N₂, was introduced at a constant mass flow rate of 200 SCCM. To the degasser column, a feed gas stream of 100% N₂, was introduced at a constant mass flow rate of 200 SCCM. FIG. 7A shows the concentration of CO₂ (%) measured downstream of each of the three columns in the redox flow acid-gas capture device. In FIG. 7B, these concentrations are converted molar capture and release rates (mmol/hr) where the sum of the difference between 1% and the measurement for both the absorber and stripper columns is the captured total and the molar flow rate of CO₂ leaving the degasser is the release rate. FIG. 7C shows the O₂ concentrations downstream of each of three columns over the same period of measurement. Notably, after changing the gas composition of the feed gas to the absorber, there is no detectable change in the PPM-level O₂ leaving the degasser unit, indicating that nearly all of the dissolved O₂ is removed by the O₂ stripper.

This disclosure further encompasses the following aspects.

Aspect 1: A redox flow acid-gas capture system comprising: an electrochemical cell comprising a cathode configured to contact a stream comprising an electroactive species in an inactive state and provide a reduced stream comprising the electroactive species in an active state, and an anode configured to contact an adduct stream comprising an adduct of an electroactive species and an acid-gas and provide an oxidized stream comprising the electroactive species in the inactive state and the acid-gas; an absorber configured to contact the reduced stream comprising the electroactive species in the active state and the acid-gas and form the adduct stream comprising the adduct of the electroactive species and the acid-gas; and at least one of an oxygen stripper unit configured to remove O₂ from the adduct stream and provide a stripped adduct stream having an O₂ content that is less than an O₂ content of the adduct stream to the oxidizer and a stripped-gas stream, a degasser unit configured to provide a degassed stream comprising the electroactive species in an inactive state, and an acid-gas stream, or wherein the electrochemical cell is configured to provide a degassed stream comprising the electroactive species in the oxidized state and the acid-gas stream.

Aspect 2: The redox flow acid-gas capture system of aspect 1, wherein the stream comprising the electroactive species in the inactive state comprises a first electrolyte comprising a solvent.

Aspect 3: The redox flow acid-gas capture system of aspects 1 or 2, wherein a residence time of the adduct stream in the absorber is less than 20 minutes.

Aspect 4: The redox flow acid-gas capture system of any of aspects 1 to 3, further comprising a pump configured to provide a residence time of the adduct stream in the absorber that is less than a residence time in the absorber without the pump.

Aspect 5: The redox flow acid-gas capture system of any of aspects 1 to 4, wherein the absorber is configured to provide a residence time of the adduct stream in the absorber that is less than a residence time in a conventional absorber, preferably, wherein the absorber is a rotating packed bed absorber.

Aspect 6: The redox flow acid-gas capture system of any of aspects 1 to 5, wherein the absorber comprises a feed gas inlet, a feed gas outlet, a reduced stream inlet in fluid communication with the cathode, and an adduct stream outlet.

Aspect 7: The redox flow acid-gas capture system of any of aspects 1 to 6, wherein the system comprises the oxygen stripper, and an adduct stream inlet of the oxygen stripper is in fluid communication with an outlet of the absorber, an adduct stream outlet of the oxygen stripper is in fluid communication with the anode, and the oxygen stripper further comprises a gas outlet, wherein the oxygen stripper is configured to reduce an oxygen content of the adduct stream.

Aspect 8: The redox flow acid-gas capture system of any of aspects 1 to 6, wherein the system comprises the degasser unit, and an oxidized stream inlet of the degasser unit is in fluid communication with an outlet of the electrochemical cell, an oxidized stream outlet of the degasser unit is in fluid communication with an inlet of the electrochemical cell, and the degasser unit further comprises a gas outlet, wherein the degasser unit is configured to provide a degassed stream comprising the electroactive species in an inactive state, preferably wherein the degassed stream has an oxygen content that is less than an oxygen content of the oxidized stream.

Aspect 9: The redox flow acid-gas capture system of aspect 8, further comprising an oxygen stripper unit, wherein the acid-gas stream is removed from the gas outlet of the degasser unit and provided to a gas inlet of the oxygen stripper unit, and an adduct stream outlet of the oxygen stripper unit is in fluid communication with an inlet of the electrochemical cell.

Aspect 10: The redox flow acid-gas capture system of any of aspects 1 to 6, wherein the electrochemical cell is configured to remove O₂ from the oxidized stream and provide a degassed oxidized stream comprising the electroactive species in the oxidized state and the acid-gas stream; wherein an acid-gas stream outlet of the electrochemical cell is in fluid communication with an inlet of an acid-gas stream compressor or an acid-gas recovery unit.

Aspect 11: The redox flow acid-gas capture system of any of aspects 7 to 10, further comprising a pump configured to reduce pressure in the oxygen stripper unit, the degasser unit, or both.

Aspect 12: A redox flow acid-gas capture system comprising: a first electrochemical cell comprising a cathode configured to contact a first stream comprising an electroactive species in an inactive state and provide a reduced stream comprising the electroactive species in an active state, and an anode configured to contact a second stream comprising a second electroactive species in a reduced state and provide the second electroactive species in an oxidized state; an absorber configured to contact the electroactive species in the active state and an acid-gas and form an adduct stream comprising an adduct of the first electroactive species and the acid-gas; a second electrochemical cell comprising a cathode configured to reduce the second electroactive species in the oxidized state and provide the second electroactive species in the reduced state, and an anode configured to oxidize the adduct and provide an oxidized stream comprising the electroactive species in the inactive state and the acid-gas; and a degasser configured to separate the acid-gas and oxygen from the oxidized stream comprising the electroactive species in the inactive state and the acid-gas and provide a degassed stream comprising the electroactive species in the inactive state having an oxygen content that is less than an oxygen content of the oxidized stream.

Aspect 13: The redox flow acid-gas capture system of aspect 12, further comprising a counter loop comprising a complementary electroactive species stream comprising a complementary electroactive species.

Aspect 14: The redox flow acid-gas capture system of any of aspects 1 to 13, wherein the electrochemical cell is a multicell stack comprising a plurality of electrochemical cells.

Aspect 15: The redox flow acid-gas capture system of any of aspects 1 to 14, wherein the acid-gas comprises a Lewis acid-gas.

Aspect 16: The redox flow acid-gas capture system of any of aspects 1 to 15, wherein the acid-gas is capable of forming an adduct with the electroactive species in a reduced state, preferably wherein the acid-gas is capable of forming a covalent or non-covalent adduct with the electroactive species in a reduced state.

Aspect 17: The redox flow acid-gas capture system of any of aspects 1 to 16, wherein the acid-gas comprises carbon dioxide, sulfur dioxide, sulfur trioxide, an organosulfate, a nitrogen oxide, a phosphate ester, a borane, or a combination thereof.

Aspect 18: The redox flow acid-gas capture system of any of aspects 1 to 17, wherein the electroactive species comprises an electroactive polymer, an electroactive oligomer, an electroactive organic compound, or a combination thereof; preferably a substituted or unsubstituted quinone or tetrone, preferably benzoquinone, 1,4-naphthoquinone, 1,2-naphthoquinone, anthraquinone, phenanthrenequinone, benzanthraquinone, dibenzoanthraquinone, 4,5,9,10-pyrenetetrone, or a combination thereof; or a polymer or oligomer comprising repeating units derived from a substituted or unsubstituted quinone or tetrone, preferably a polymer comprising repeating units derived from benzoquinone, 1,4-naphthoquinone, 1,2-naphthoquinone, anthraquinone, phenanthrenequinone, benzanthraquinone, dibenzoanthraquinone, 4,5,9,10-pyrenetetrone, or a combination thereof.

Aspect 19: The redox flow acid-gas capture system of any of aspects 13 to 18, wherein the complementary electroactive species comprises an electroactive organic compound, an electroactive inorganic complex, an electroactive organometallic complex, or a combination thereof, preferably a ferrocene.

Aspect 20: The redox flow acid-gas capture system of any of aspects 13 to 19, wherein the complementary electroactive species is a same species as the electroactive species.

Aspect 21: The redox flow acid-gas capture system of any of aspects 2 to 9, wherein the electroactive species is present in the electrolyte in a concentration of 0.001 to 2 M.

Aspect 22: The redox flow acid-gas capture system of any of aspects 2 to 9, wherein the electroactive species in the reduced state is present in the electrolyte in a concentration of 0.001 to 2 M.

Aspect 23: The redox flow acid-gas capture system of any of aspects 1 to 22, wherein the electroactive species is a solid at 20° C.

Aspect 24: The redox flow acid-gas capture system of any of aspects 1 to 23, wherein the adduct stream further comprises a first electrolyte acid-gas and comprises 0.05 to 0.4 grams of CO₂ per gram of electroactive species.

Aspect 25: The redox flow acid-gas capture system of any of aspects 1 to 24, further comprising a blower, a compressor, or combination thereof configured to compress the acid-gas stream.

Aspect 26: A method of separating a target gas from a fluid mixture, the method comprising providing the fluid mixture to the redox flow acid-gas capture system of any one or more of aspects 1 to 25.

Aspect 27: The method of aspect 26, wherein the method is a continuous method.

Aspect 28: The method of aspect 26 or 27, the method comprising: contacting the fluid mixture with an electroactive species in the absorber of the redox flow acid-gas capture system, wherein the electroactive species is capable of binding with a target gas when the electroactive species is in a reduced state and releasing the target gas when the electroactive species is in an oxidized state.

Aspect 29: The method of aspect 28, wherein the reduced state is a monoanion or dianion derivative of the electroactive species, and the oxidized state is a neutral species of the electroactive species.

Aspect 30: The method of aspect 28 or 29, wherein the reduced state is a dianion derivative of the electroactive species, and the oxidized state is a monoanion derivative of the electroactive species.

The terminology used herein is for the purpose of describing particular embodiments only and is not intended to be limiting of the invention. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements and the thicknesses of layers and regions are exaggerated for clarity.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A redox flow acid-gas capture system comprising:
an electrochemical cell comprising
a cathode configured to contact a stream comprising an electroactive species in an inactive state and provide a reduced stream comprising the electroactive species in an active state, and
an anode configured to contact an adduct stream comprising an adduct of an electroactive species and an acid-gas and provide an oxidized stream comprising the electroactive species in the inactive state and the acid-gas;
an absorber configured to contact the reduced stream comprising the electroactive species in the active state and the acid-gas and form the adduct stream comprising the adduct of the electroactive species and the acid-gas; and
at least one of
an oxygen stripper unit configured to remove O₂ from the adduct stream and provide to the oxidizer a stripped adduct stream having an O₂ content that is less than an O₂ content of the adduct stream and a stripped-gas stream,
a degasser unit configured to provide a degassed stream comprising the electroactive species in an inactive state, and an acid-gas stream, or
wherein the electrochemical cell is configured to provide a degassed stream comprising the electroactive species in the oxidized state and the acid-gas stream.

2. The redox flow acid-gas capture system of claim 1, wherein the stream comprising the electroactive species in the inactive state comprises a first electrolyte comprising a solvent.

3. The redox flow acid-gas capture system of claim 1, wherein a residence time of the adduct stream in the absorber is less than 20 minutes.

4. The redox flow acid-gas capture system of claim 1, wherein the absorber is a rotating packed bed absorber.

5. The redox flow acid-gas capture system of claim 1, wherein the absorber comprises a feed gas inlet, a feed gas outlet, a reduced stream inlet in fluid communication with the cathode, and an adduct stream outlet.

6. The redox flow acid-gas capture system of claim 1,
wherein the system comprises the oxygen stripper, and
an adduct stream inlet of the oxygen stripper is in fluid communication with an outlet of the absorber,
an adduct stream outlet of the oxygen stripper is in fluid communication with the anode, and
the oxygen stripper further comprises a gas outlet,
wherein the oxygen stripper is configured to reduce an oxygen content of the adduct stream.

7. The redox flow acid-gas capture system of claim 1,
wherein the system comprises the degasser unit, and
an oxidized stream inlet of the degasser unit is in fluid communication with an outlet of the electrochemical cell,
an oxidized stream outlet of the degasser unit is in fluid communication with an inlet of the electrochemical cell, and
the degasser unit further comprises a gas outlet,
wherein the degasser unit is configured to provide a degassed stream comprising the electroactive species in an inactive state, preferably wherein the degassed stream has an oxygen content that is less than an oxygen content of the oxidized stream;
optionally, wherein the redox flow acid-gas capture system further comprises an oxygen stripper unit, wherein
the acid-gas stream is removed from the gas outlet of the degasser unit and provided to a gas inlet of the oxygen stripper unit, and
an adduct stream outlet of the oxygen stripper unit is in fluid communication with an inlet of the electrochemical cell.

8. The redox flow acid-gas capture system of claim 1,
wherein the electrochemical cell is configured to provide a degassed oxidized stream comprising the electroactive species in the oxidized state and the acid-gas stream;
wherein an acid-gas stream outlet of the electrochemical cell is in fluid communication with an inlet of an acid-gas stream compressor or an acid-gas recovery unit.

9. The redox flow acid-gas capture system of claim 1, further comprising a pump configured to reduce pressure in the oxygen stripper unit, the degasser unit, or both.

10. A redox flow acid-gas capture system comprising:
a first electrochemical cell comprising
a cathode configured to contact a first stream comprising an electroactive species in an inactive state and provide a reduced stream comprising the electroactive species in an active state, and
an anode configured to contact a second stream comprising a second electroactive species in a reduced state and provide the second electroactive species in an oxidized state;
an absorber configured to contact the electroactive species in the active state and an acid-gas and form an adduct stream comprising an adduct of the first electroactive species and the acid-gas;
a second electrochemical cell comprising
a cathode configured to reduce the second electroactive species in the oxidized state and provide the second electroactive species in the reduced state, and
an anode configured to oxidize the adduct and provide an oxidized stream comprising the electroactive species in the inactive state and the acid-gas; and
a degasser configured to separate the acid-gas and oxygen from the oxidized stream comprising the electroactive species in the inactive state and the acid-gas and provide a degassed stream comprising the electroactive species in the inactive state having an oxygen content that is less than an oxygen content of the oxidized stream.

11. The redox flow acid-gas capture system of claim 10, further comprising a counter loop comprising a complementary electroactive species stream comprising a complementary electroactive species, wherein the complementary electroactive species comprises an electroactive organic compound, an electroactive inorganic complex, an electroactive organometallic complex, or a combination thereof.

12. The redox flow acid-gas capture system of claim 11, wherein the complementary electroactive species is a same species as the electroactive species.

13. The redox flow acid-gas capture system of claim 1, wherein the electrochemical cell is a multicell stack comprising a plurality of electrochemical cells.

14. The redox flow acid-gas capture system of claim 1, wherein
the acid-gas comprises a Lewis acid-gas;
the electroactive species is a solid at 20° C.; and
the electroactive species comprises an electroactive polymer, an electroactive oligomer, an electroactive organic compound, or a combination thereof.

15. The redox flow acid-gas capture system of claim 1, wherein the acid-gas is capable of forming a covalent or non-covalent adduct with the electroactive species in a reduced state.

16. The redox flow acid-gas capture system of claim 1, wherein
the electroactive species is present in the electrolyte in a concentration of 0.001 to 2 M; or
wherein the electroactive species in the reduced state is present in the electrolyte in a concentration of 0.001 to 2 M.

17. The redox flow acid-gas capture system of claim 1, wherein the adduct stream further comprises a first electrolyte acid-gas and comprises 0.05 to 0.4 grams of CO₂ per gram of electroactive species.

18. The redox flow acid-gas capture system of claim 1, further comprising a blower, a compressor, or combination thereof configured to compress the acid-gas stream.

19. A method of separating a target gas from a fluid mixture, the method comprising providing the fluid mixture to the redox flow acid-gas capture system of claim 1, the method comprising:
contacting the fluid mixture with an electroactive species in the absorber of the redox flow acid-gas capture system, wherein the electroactive species is capable of binding with a target gas when the electroactive species is in a reduced state and releasing the target gas when the electroactive species is in an oxidized state,
wherein the reduced state is a monoanion or dianion derivative of the electroactive species, and the oxidized state is a neutral species of the electroactive species, and
wherein the reduced state is a dianion derivative of the electroactive species, and the oxidized state is a monoanion derivative of the electroactive species.

20. The method of claim 19, wherein the method is a continuous method.
